(19) United States
(12) Patent Application Publication
(10) Pub. No.: US 2024/0343656 A1
(43) Pub. Date: Oct. 17, 2024

(54) PORE-STRUCTURED CERAMIC NANOPARTICLES, PORE-STRUCTURED CERAMIC NANOPARTICLES-CARBON ALLOTROPE COMPOSITE, AND METHOD FOR MANUFACTURING THE SAME

(71) Applicant: UNIVERSITY-INDUSTRY COOPERATION GROUP OF KYUNG HEE UNIVERSITY, Yongin-si, Gyeonggi-do (KR)

(72) Inventors: Sun Ho JEONG, Yongin-si (KR); Yeong Je LEE, Jeonju-si (KR)

(73) Assignee: UNIVERSITY-INDUSTRY COOPERATION GROUP OF KYUNG HEE UNIVERSITY, Yongin-si, Gyeonggi-do (KR)

(21) Appl. No.: 18/580,450

(22) PCT Filed: Jul. 20, 2022
(86) PCT No.: PCT/KR2022/010585

§ 371 Date: Jan. 18, 2024

(30) Foreign Application Priority Data
Aug. 26, 2021 (KR) 10-2021-0112920

(51) Int. Cl. C04B 38/00; B82Y 40/00

(52) U.S. Cl. CPC C04B 38/009; B82Y 40/00; C04B 38/0093; C04B 2235/3418; C04B 2235/5454; C04B 2235/95

(57) ABSTRACT

Disclosed are a ceramic nanoparticle-carbon allotrope composite having a pore structure, and a method of manufacturing the same. According to an embodiment of the present invention, by modifying the surface of ceramic nanoparticles using a polymer containing a polar functional group, a porous-structured ceramic nanoparticle-carbon allotrope composite in which the particles are evenly distributed in a carbon allotrope can be provided.

### CROSS-REFERENCE TO RELATED APPLICATION

This application is a National Stage Entry of PCT International Application No. PCT/KR2022/010585, which was filed on Jul. 20, 2022, and which claims priority to Korean Patent Application No. 10-2021-0112920, filed on Aug. 26, 2021 in the Korean Intellectual Property Office, the invention of which is incorporated herein by reference.

### TECHNICAL FIELD

The present invention relates to ceramic nanoparticles with a pore structure, a composite manufactured by combining the ceramic nanoparticles with a carbon allotrope and a method of manufacturing each of the ceramic nanoparticles and the composite.

### BACKGROUND ART

Nanoscale materials can have new physical properties or improve the physical properties of existing materials, and are known to allow detailed control of material properties. In addition, nanoparticles have the advantage of having a large surface area. Due to these characteristics, nanoparticles can be applied to various fields such as semiconductors, catalysts, and cosmetics.

When an organic compound is combined with ceramic nanoparticles, a type of nanoparticle, an organic-inorganic hybrid composite material is created. This composite material can be applied to catalysts, electronic materials, etc. due to the high mechanical strength and heat resistance of the ceramic and the low dielectric constant characteristics of the organic material. In addition, ceramic particles with a pore structure have the advantage of being able to control optical, electrical, and electrochemical properties depending on not only the physicochemical properties of the ceramic material itself but also the volume fraction of the internal structure containing air.

However, ceramic nanoparticles have a problem in that they tend to aggregate with each other. Accordingly, when combining these ceramic nanoparticles with a sheet-shaped carbon material, the ceramic nanoparticles are not evenly bonded to the carbon material, so there are parts where the carbon material is exposed. Therefore, so as to manufacture solution-phase nanocrystal particle materials, it is necessary to improve a process step of causing particle aggregation or introduce a new process concept. To solve this problem, there is a need for techniques of synthesizing ceramic nanoparticles with a pore structure having controlled cohesion and a composite created by combining the ceramic nanoparticles with a carbon allotrope.

### RELATED ART DOCUMENT

### Patent Document

Korean Patent No. 10-1504673, “ACIDIC OXIDE NANOPARTICLES HAVING 3-DIMENSIONAL OPEN PORES, METHOD FOR PREPARING THE SAME AND METHOD FOR PRODUCING ACROLEIN OR ACRYLIC ACID FROM GLYCEROL USING THE SAME”

### DISCLOSURE

### Technical Problem

Therefore, the present invention has been made in view of the above problems, and it is one object of the present invention to synthesize ceramic nanoparticles having a pore structure by introducing an emulsion mechanism.

It is another object of the present invention to control agglomeration between ceramic nanoparticles by using a surface modification additive.

It is still another object of the present invention to manufacture a porous-structured ceramic nanoparticle-carbon allotrope composite by combining ceramic nanoparticles having increased dispersion with a carbon material.

It is yet another object of the present invention to manufacture a porous-structured ceramic nanoparticle-carbon allotrope composite that can be applied as an active electrode material for secondary batteries, a 5G low dielectric material and a radiant heat dissipation material.

### Technical Solution

In accordance with an aspect of the present invention, the above and other objects can be accomplished by the provision of a method of manufacturing pore-structured ceramic nanoparticles, the method including: a step of adding a surfactant to a solvent to produce a first mixed solution; a step of adding a ceramic precursor to the first mixed solution to produce a second mixed solution; and a step of adding a surface modification additive to the second mixed solution to obtain ceramic nanoparticles having controlled cohesion.

According to an embodiment, the solvent may include alcohol and water.

According to an embodiment, the surfactant may be one selected from the group consisting of cetrimonium bromide (CTAB), triethylamine hydrochloride (TAHC), benzethonium chloride (BTC), cetylpyridinium chloride (CPC) dimethyldioctadecylammonium chloride (DOAC), sodiumdodecylsulfate (SDS), sodiumdodecylbenzenesulfonate (SDBS) and dodecyltrimethylammonium bromide (DTAB).

According to an embodiment, a volume ratio of the alcohol to water may be 0.30 to 0.80.

According to an embodiment, the ceramic precursor may be one selected from the group consisting of tetraethylorthosilicate (TEOS), triethoxyvinylsilane (TEV), (3-mercaptopropyl) trimethoxysilane (MPTMS), tetramethoxysilane (TMOS), triethoxyethylsilane (TEES), 1,2-bis(triethoxysilyl)ethane (BTSE), zirconium tert-butoxide, zirconium ethoxide, zirconium propoxide, titanium ethoxide, titanium isopropoxide, aluminum isopropoxide, aluminum-tri-sec-butoxide, aluminum tert-butoxide, hafnium n-butoxide, hafnium tert-butoxide, vanadium oxytriethoxide, vanadium oxytripropoxide, vanadium oxytriisopropoxide, yttrium tris(isopropoxide) and tin(IV) tert-butoxide.

According to an embodiment, the first precipitate may be one selected from the group consisting of silica (SiO₂), zirconium oxide (ZrO₂), titanium oxide (TiO₂), aluminum oxide (Al₂O₃), hafnium oxide (HfO₂), vanadium oxide (V₂O₃), yttrium oxide (Y₂O₃) and tin oxide (SnO and SnO₂).

According to an embodiment, the surface modification additive may be a polymer including a polar and charged functional group, wherein the polar functional group is one selected from the group consisting of a sulfonyl group, an amino group, an amide group, an ether group, a carboxyl group and a hydroxyl group.

According to an embodiment, the polymer may be one selected from the group consisting of poly(sodium 4-styrene-sulfonate (PSS), poly(allyl-amine e hydrochloride) (PAH), poly(diallyldimethylammonium chloride) (PDAC), polyvinyl pyrrolidone (PVP), poly(N,N-dimethylacrylamide), poly(2-methyl-2-oxazoline), polyvinyl alcohol (PVA), polyethylenimine (PEI), polypropylene glycol (PPG), polyethylene glycol (PEG) and poly(acrylic acid) (PAA).

According to an embodiment, the ceramic nanoparticles may have a zeta potential of ±20 mV to ±50 mV.

In accordance with another aspect of the present invention, provided is a method of manufacturing a porous-structured ceramic nanoparticle-carbon allotrope composite, the method including: a step of adding a surfactant to a solvent to produce a first mixed solution; a step of adding a ceramic precursor to the first mixed solution to produce a second mixed solution; a step of adding a surface modification additive to the second mixed solution to produce a third mixed solution; and a step of adding the third mixed solution to a carbon allotrope dispersion solution to obtain a porous-structured ceramic nanoparticle-carbon allotrope composite having controlled cohesion.

According to an embodiment, the carbon allotrope may be one selected from the group consisting of graphene, graphene oxide, graphene nanoribbon (GNR), carbon nanotube, carbon nanofiber, graphite, and expanded graphite.

In accordance with still another aspect of the present invention, provided are pore-structured ceramic nanoparticles having controlled cohesion according to the method of manufacturing pore-structured ceramic nanoparticles.

According to an embodiment, the ceramic nanoparticles may have a zeta potential value of ±20 mV to ±50 mV.

In accordance with still another aspect of the present invention, provided a porous-structured ceramic nanoparticle-carbon allotrope composite having controlled cohesion according to the method of manufacturing a porous-structured ceramic nanoparticle-carbon allotrope composite.

According to an embodiment, the ceramic nanoparticle-carbon allotrope composite may have a zeta potential value of ±30 mV to ±50 mV.

### Advantageous Effects

In accordance with the present invention, ceramic nanoparticles having a pore structure can be derived through the interfacial synthesis of an emulsion mechanism.

In accordance with the present invention, ceramic nanoparticles can be surface-modified using a surface modification additive.

In accordance with the present invention, the surface-modified ceramic nanoparticles have a large zeta potential.

In accordance with the present invention, a homogeneous ceramic-carbon allotrope composite can be produced by using the surface-modified ceramic nanoparticles and a carbon allotrope material together.

### DESCRIPTION OF DRAWINGS

FIG. 1a illustrates a flowchart of a method of manufacturing pore-structured ceramic nanoparticles according to the present invention.

FIG. 1b illustrates a flowchart of a method of manufacturing a porous-structured ceramic nanoparticle-carbon allotrope composite according to the present invention.

FIGS. 2a and 2b illustrate a scanning electron microscope (SEM) image of silica synthesized with a TEOS precursor according to Comparative Example 1-1 of the present invention.

FIGS. 3a and 3b illustrate a scanning electron microscope (SEM) image of silica added with PVP and synthesized with a TEOS precursor according to Example 1-1 of the present invention.

FIG. 4a illustrates a scanning electron microscope (SEM) image of a silica-graphene oxide composite synthesized with a TEOS precursor according to Comparative Example 1-2 of the present invention.

FIG. 4b illustrates a scanning electron microscope (SEM) image of a silica-graphene oxide composite added with PVP and synthesized with a TEOS precursor according to Example 1-2 of the present invention.

FIG. 5 illustrates a scanning electron microscope (SEM) image of silica added with PVP and synthesized with a TEV precursor according to Example 2-1 of the present invention.

FIG. 6 illustrates a scanning electron microscope (SEM) image of a silica-graphene oxide composite added with PVP and synthesized with a TEV precursor according to Example 2-2 of the present invention.

### BEST MODE

The present invention will now be described more fully with reference to the accompanying drawings and contents disclosed in the drawings. However, the present invention should not be construed as limited to the exemplary embodiments described herein. The terms used in the present specification are used to explain a specific exemplary embodiment and not to limit the present inventive concept. Thus, the expression of singularity in the present specification includes the expression of plurality unless clearly specified otherwise in context.

It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

In addition, as used in the description of the invention and the appended claims, the singular forms “a”, “an” and “the” are intended to include the plural forms as well, unless context clearly indicates otherwise.

Although terms used in the specification are selected from terms generally used in related technical fields, other terms may be used according to technical development and/or due to change, practices, priorities of technicians, etc.

Therefore, it should not be understood that terms used below limit the technical spirit of the present invention, and it should be understood that the terms are exemplified to describe embodiments of the present invention.

Also, some of the terms used herein may be arbitrarily chosen by the present applicant. In this case, these terms are defined in detail below. Accordingly, the specific terms used herein should be understood based on the unique meanings thereof and the whole context of the present invention.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

Meanwhile, in the following description of the present invention, a detailed description of known functions and configurations incorporated herein will be omitted when it may make the subject matter of the present invention unclear.

The terms used in the specification are defined in consideration of functions used in the present invention, and can be changed according to the intent or conventionally used methods of clients, operators, and users. Accordingly, definitions of the terms should be understood on the basis of the entire description of the present specification.

Now, a method of manufacturing ceramic nanoparticles with a pore structure according to the present invention is described with reference to the accompanying drawings.

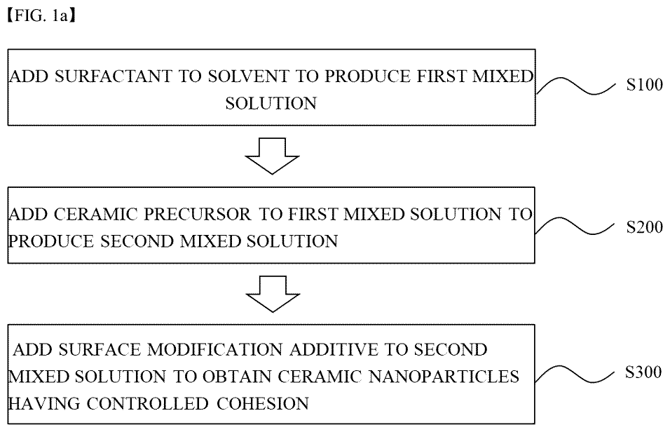

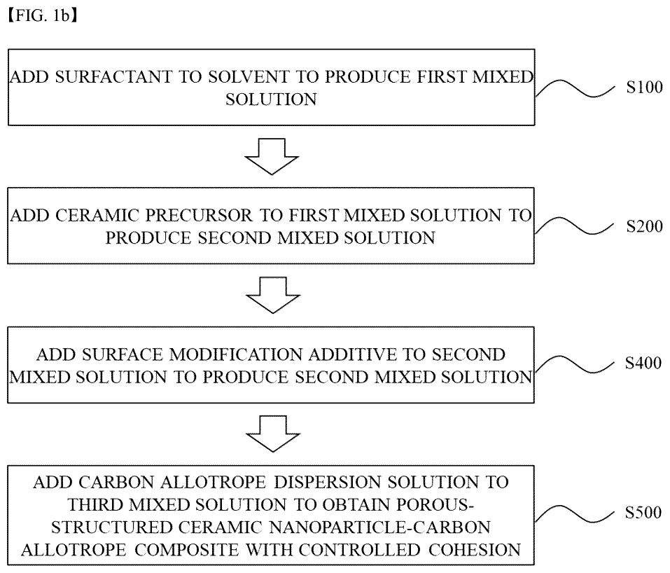

FIG. 1a is a flowchart illustrating a method of manufacturing ceramic nanoparticles with a pore structure according to an embodiment of the present invention. Referring to FIG. 1a, the method of manufacturing ceramic nanoparticles includes a step of adding a surfactant to a solvent to produce a first mixed solution, a step (S200) of adding a ceramic precursor to the first mixed solution to produce a second mixed solution and a step (S300) of adding a surface modification additive to the second mixed solution to obtain ceramic nanoparticles having controlled cohesion.

In the step (S100) of adding a surfactant to a solvent to produce a first mixed solution of the method of manufacturing ceramic nanoparticles with a pore structure, the solvent includes alcohol and water. Alcohol and water are mixed and stirred in a volume ratio of 0.30 to 0.80. Preferably, alcohol and water are mixed in a volume ratio of 0.40 to 0.60. The alcohol is one selected from among ethanol, methanol, isopropyl alcohol, methoxyethanol and acetone. Preferably, ethanol may be used. Here, ethanol and water are mixed in a volume ratio of 0.30 to 0.80. Preferably, ethanol and water are mixed in a volume ratio of 0.40 to 0.60.

The surfactant is an ionic surfactant, and the ionic surfactant is one selected from among cetrimonium bromide (CTAB), triethylamine hydrochloride (TAHC), benzethonium chloride (BTC), cetylpyridinium chloride (CPC) dimethyldioctadecylammonium chloride (DOAC), sodiumdodecylsulfate (SDS), sodiumdodecylbenzenesulfonate (SDBS) and dodecyltrimethylammonium bromide (DTAB). Preferably, CTAB is used.

The step (S200) of adding a ceramic precursor to the first mixed solution to produce a second mixed solution includes a process of adding a catalyst before centrifugation after adding a ceramic precursor. the catalyst is an acid or basic catalyst. The acid catalyst may be one selected from among hydrochloric acid (HCl) and sulfuric acid (H₂SO₄), and the basic catalyst may be one selected from among ammonium hydroxide (NH₄OH) and sodium hydroxide (NaOH). Preferably, ammonium hydroxide (NH₄OH) is used. Here, the catalyst is used to synthesize a particle-shaped ceramic material rather than a polymer chain-shaped ceramic material from a precursor. Ceramic particles may be synthesized through hydration and polymerization reactions of a precursor in a radial direction rather than a linear direction.

The ceramic precursor may be one selected from the group consisting of tetraethylorthosilicate (TEOS), triethoxyvinylsilane (TEV), (3-mercaptopropyl) trimethoxysilane (MPTMS), tetramethoxysilane (TMOS), triethoxyethylsilane (TEES), 1,2-bis(triethoxysilyl)ethane (BTSE), zirconium tert-butoxide, zirconium ethoxide, zirconium propoxide, titanium ethoxide, titanium isopropoxide, aluminum isopropoxide, aluminum-tri-sec-butoxide, aluminum tert-butoxide, hafnium n-butoxide, hafnium tert-butoxide, vanadium oxytriethoxide, vanadium oxytripropoxide, vanadium oxytriisopropoxide, yttrium tris(isopropoxide), and tin(IV) tert-butoxide.

Ceramic nanoparticles are generated in the second mixed solution. A ceramic generated from the ceramic precursor may be one selected from the group consisting of silica (SiO₂), zirconium oxide (ZrO₂), titanium oxide (TiO₂), aluminum oxide (Al₂O₃), hafnium oxide (HfO₂), vanadium oxide (V₂O₃), yttrium oxide (Y₂O₃) and tin oxide (SnO and SnO₂).

The ceramic nanoparticles have a pore structure due to the introduction of an emulsion mechanism. The emulsion mechanism refers to the composition of an oil-in-water emulsion in which alcohol and precursor act as oil. the synthesis reaction of ceramic oxide is promoted on the surface of the emulsion by using an ionic surfactant that can chemically bond with a charged ceramic oxide when the emulsion is formed. In addition, the precursor contained within the emulsion is synthesized in the form of a shell through a chemical reaction with water and catalyst contained on the outside. That is, it is a reaction mechanism wherein a ceramic shell grows through diffusion of water and a catalyst into the emulsion. Here, the emulsion mechanism can synthesize ceramic particles with a pore structure by controlling a reaction time and speed. Ceramic particles with a pore structure have the advantage of being able to control optical, electrical, and electrochemical properties depending on not only the physicochemical properties of the ceramic material itself but also the volume fraction of the internal structure containing air.

The step (S300) of adding a surface modification additive to the second mixed solution to obtain ceramic nanoparticles having controlled cohesion includes a process of adding a surface modification additive and then stirring and centrifuging the same. As a result, ceramic nanoparticles having controlled cohesion can be obtained. The ceramic nanoparticles having controlled cohesion are produced in a size of 100 nm to 700 nm, and pores in the particles are formed in a size of 10 nm to 500 nm.

The surface modification additive is a polymer containing a polar and charged functional group, and the polar functional group may be a functional group having a sulfonyl group, an amino group, an amide group, an ether group, a carboxyl group or a hydroxyl group. In addition, the polymer may be one selected from the group consisting of poly(sodium 4-styrene-sulfonate (PSS), poly(allyl-amine hydrochloride) (PAH), poly(diallyldimethylammonium chloride) (PDAC), polyvinyl pyrrolidone (PVP), poly(N,N-dimethylacrylamide), poly(2-methyl-2-oxazoline), polyvinyl alcohol (PVA), polyethylenimine (PEI), polypropylene glycol (PPG), polyethylene glycol (PEG) and poly(acrylic acid) (PAA).

The ceramic nanoparticles are colloidal particle, and colloidal particles have the property of attracting each other through attraction therebetween. This attraction causes agglomeration. To prevent this, a surface modification additive was used. A surface charge is formed according to the adsorption of a surface modification additive to the surface of ceramic particles. Due to the repulsion between charges, the pore structure of ceramic particles is maintained while cohesion is significantly reduced.

FIG. 1b is a flowchart illustrating a method of manufacturing a pore-structured ceramic nanoparticle-carbon allotrope composite according to an embodiment of the present invention. Referring to FIG. 1b, the method of manufacturing the method of manufacturing a pore-structured ceramic nanoparticle-carbon allotrope composite includes a step (S100) of adding a surfactant to a solvent to produce a first mixed solution, a step (S200) of adding a ceramic precursor to the first mixed solution to produce a second mixed solution, a step (S400) of adding a surface modification additive to the second mixed solution to produce a third mixed solution and a step (S500) of adding the third mixed solution to a carbon allotrope dispersion solution to obtain a porous-structured ceramic nanoparticle-carbon allotrope composite having controlled cohesion.

S100 and S200 are the same as the method of manufacturing the pore-structured ceramic nanoparticles, so overlapping descriptions are omitted.

The step (S400) of adding a surface modification additive to the second mixed solution to produce a third mixed solution includes a step of centrifuging the third mixed solution after adding the surface modification additive to obtain ceramic nanoparticles and dispersing the ceramic nanoparticles in water.

The obtained ceramic nanoparticles have a size of 100 nm to 700 nm, and the size of pores in the particles is 10 nm to 500 nm.

The third mixed solution is stirred while being added drop by drop to the carbon allotrope dispersion solution, and the stirred solution is centrifuged to generate a precipitate. The precipitate is a porous-structured ceramic nanoparticle-carbon allotrope composite having controlled cohesion (S500). The carbon allotrope dispersion solution refers to a solution in which a carbon allotrope is dispersed in a polar solvent. Preferably, water may be used as a polar solvent. To achieve a homogeneous interfacial reaction with the third mixed solution, i.e., the pore-structured ceramic nanoparticles, a method of adding drop by drop while stirring is used.

The carbon allotrope refers to substances made only of carbon and having various properties. The carbon allotrope may be one selected from the group consisting of graphene, graphene oxide, graphene nanoribbon (GNR), carbon nanotube, carbon nanofiber, graphite and expanded graphite. Preferably, graphene oxide may be selected.

In the composite, the degree of cohesion of the ceramic particles is greatly reduced, allowing each particle to individually bond to the surface of the carbon allotrope. The ceramic nanoparticle-carbon allotrope composite generated according to the present invention has excellent homogeneity. In the present invention, the expressions “homogeneity is excellent”, “cohesion is controlled” and “there is no cohesion (at all)” means that ceramic particles are dispersed, and the degree of dispersion can be known through zeta potential measurements.

Meanwhile, a surface modification additive plays a characteristic role in improving the surface charge of ceramic particles by adsorbing on the surface of ceramic particles. At the same time, it plays a role in inducing an interfacial chemical bond with a carbon allotrope. When a surface modification additive is first adsorbed to a carbon allotrope, most of polar functional groups of the surface modification additive are adsorbed to the carbon allotrope, so the role of controlling the surface charge of ceramic particles cannot be expected. When using ceramic particles with severe inter-particle agglomeration, it is impossible to manufacture a homogeneous composite using a carbon allotrope. Therefore, it is preferable to generate a composite with a carbon allotrope after adding a surface modification additive in a step of synthesizing pore-structured ceramic particles.

The generated carbon allotrope-ceramic particle composite is an organic-inorganic hybrid composite material, and has improved mechanical strength and heat resistance due to the ceramic, and can be applied to various functional materials because it can control dielectric constant, refractive index, thermal conductivity, and electrical conductivity.

Hereinafter, the present invention will be described in more detail through the following examples. These examples are intended to explain the present invention in more detail, and the scope of the present invention is not limited by these examples.

### [Comparative Example 1-1] Silica Synthesized Using Tetraethylorthosilicate (TEOS) Precursor

Ethanol and water were mixed in a total amount of 40.5 ml and a volume ratio of 0.60 (ethanol/water) and stirred.

Next, 5 mM of cetrimonium bromide (CTAB) was added and stirred for 5 minutes.

Next, 0.5 ml of TEOS was added and stirred for 10 minutes.

Next, 0.45 g of ammonium hydroxide (NH₄OH) catalyst was added, and then stirred at room temperature for 3 hours.

The stirred solution was centrifuged at 7000 rpm for 20 minutes to obtain a precipitate.

The precipitate was silica nanoparticles having a pore structure synthesized using a TEOS precursor.

### [Example 1-1] Silica+(PVP) Polyvinylpyrrolidone Synthesized Using TEOS Precursor

Ethanol and water were mixed in a total amount of 40.5 ml and a volume ratio of 0.60 (ethanol/water) and stirred.

Next, 5 mM of cetrimonium bromide (CTAB) was added and stirred for 5 minutes.

Next, 0.5 ml of TEOS was added and stirred for 10 minutes.

Next, 0.45 g of NH₄OH (Ammonium hydroxide) catalyst was added and stirred for 5 minutes.

Next, 150 mg of PVP (m.w.=55,000) was added, and then stirred for 3 hours at room temperature.

The stirred solution was centrifuged at 7000 rpm for 20 minutes to obtain a precipitate.

The precipitate was a material wherein the surface of pore-structured silica nanoparticles synthesized using a TEOS precursor was modified with PVP.

### [Comparative Example 1-2] Silica+Graphene Oxide Synthesized Using TEOS Precursor

25 mg of the pore structure silica particle synthesized with TEOS according to Comparative Example 1-1 was dispersed in 50 g of water, to prepare a mixed solution.

The mixed solution was added drop by drop to 12.5 g of the graphene oxide dispersion solution (concentration: 2.0 mg/ml) and stirred.

The stirred solution was centrifuged at 7000 rpm for 20 minutes to obtain a precipitate.

The precipitate was a pore-structured silica nanoparticle-carbon allotrope composite synthesized with a TEOS precursor.

### [Example 1-2] Silica+Polyvinylpyrrolidone (PVP)+Graphene Oxide Synthesized Using TEOS Precursor

25 mg of the pore structure silica particle manufactured according to Example 1-1, surface-modified with PVP and synthesized with TEOS was dispersed in 50 g of water to prepare a mixed solution.

The mixed solution was added drop by drop to 12.5 g of a graphene oxide dispersion solution (concentration: 2.0 mg/ml) and stirred.

The stirred solution was centrifuged at 7000 rpm for 20 minutes to obtain a precipitate.

The synthesized material was a pore-structured silica nanoparticle-carbon allotrope composite having a modified surface and synthesized with a TEOS precursor.

### [Example 2-1] Silica+PVP Synthesized Using Triethoxyvinylsilane (TEV) Precursor

A precipitate was obtained in the same manner as in Example 1-1 except that TEV was used instead of TEOS.

The synthesized material was pore-structured silica nanoparticles having a modified surface and synthesized with a TEV precursor.

### [Example 2-2] Silica+PVP+Graphene Oxide Synthesized Using TEV Precursor

A precipitate was obtained in the same manner as in Example 1-2 except that TEV was used instead of TEOS and the surface-modified silica particles were added in an amount of 100 mg.

The synthesized material is a pore-structured silica nanoparticle-carbon allotrope composite having a modified surface and synthesized a TEV precursor.

Hereinafter, the examples of the present invention are described in detail with reference to the accompanying drawings.

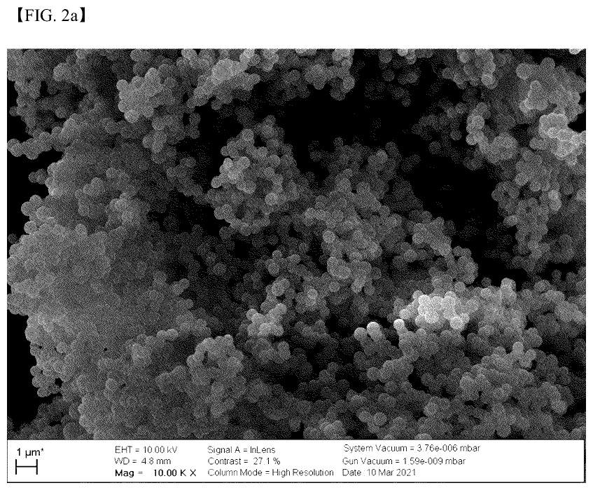

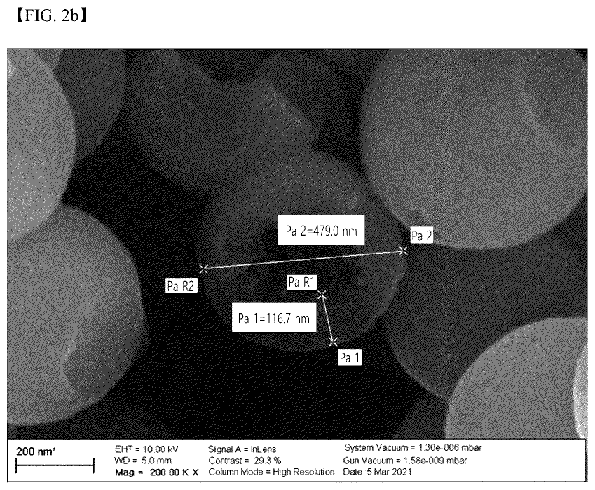

FIG. 2a illustrates an image of the pore-structured silica nanoparticles synthesized with the TEOS precursor according to Comparative Example 1-1 of the present invention observed at a magnification of 10,000 using a scanning electron microscope. As a synthesis result of silica particles according to Comparative Example 1-1, the particles were synthesized in a hollow and aggregated form.

FIG. 2b illustrates an image of the pore-structured silica nanoparticles synthesized with the TEOS precursor according to Comparative Example 1-1 of the present invention observed at a magnification of 200,000 using a scanning electron microscope. Referring to the image, the diameter (Pa 2) of each of the silica particles is about 479.0 nm, and the thickness (Pa 1) thereof is about 116.7 nm. It can be seen through calculation that the size of pores in silica particles visible from the outside is about 245.6 nm.

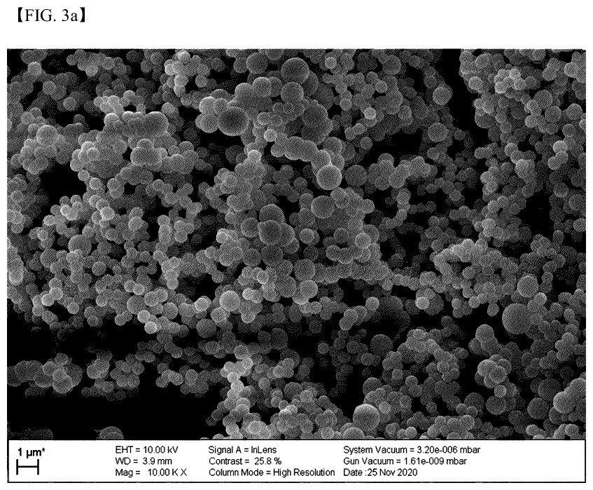

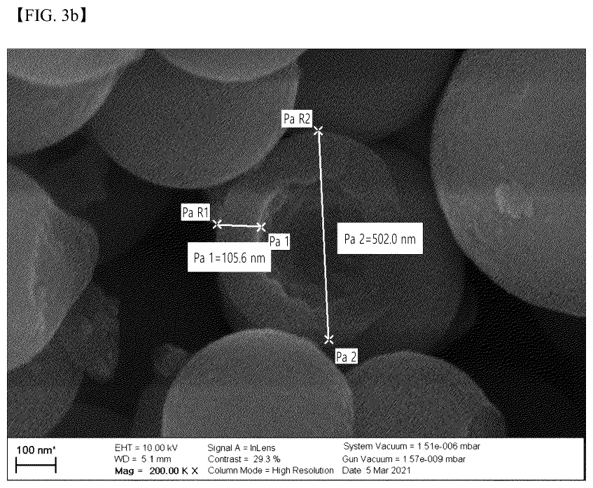

FIG. 3a illustrates an image of the pore-structured silica nanoparticles, surface-modified with PVP and synthesized with the TEOS precursor according to Example 1-1 of the present invention, observed at a magnification of 10,000 using a scanning electron microscope. Comparing FIG. 3a with FIG. 2a, it can be seen that the cohesion of silica nanoparticles is controlled. Here, the controlled cohesion can be confirmed by checking the number of aggregated particles as follows:

### <Number of Aggregated Particles>

[Comparative Example 1-1] Silica particles synthesized with TEOS: 60 to 65
[Example 1-1] Silica particles synthesized with TEOS+PVP: 15 to 20
[Example 2-2] Silica particles synthesized with TEV+PVP+graphene oxide: 0
   PVP, a surface modification additive, is a polymer that has both strong hydrophilic functional groups of C═O and C—N and a hydrophobic functional group of CH₂, and is non-toxic and non-ionic, making it chemically stable. The hydrophilic functional group, i.e, the polar functional group, of PVP binds to polar silica nanoparticles, and the hydrophobic functional group thereof induces steric repulsion. Accordingly, when PVP binds to the surface of silica nanoparticles, the cohesion between particles is decreased, and the absolute value of zeta potential also increases.

FIG. 3b illustrates an image of the pore-structured silica nanoparticles and surface-modified with PVP and synthesized with the TEOS precursor according to Example 1-1 of the present invention observed at a magnification of 200,000 using a scanning electron microscope. Referring to the image, the diameter (Pa 2) of each of the surface-modified silica particles is about 502.0 nm, and the thickness (Pa 1) thereof is about 105.6 nm. It can be seen through calculation that the size of pores in silica particles visible from the outside is about 290.8 nm.

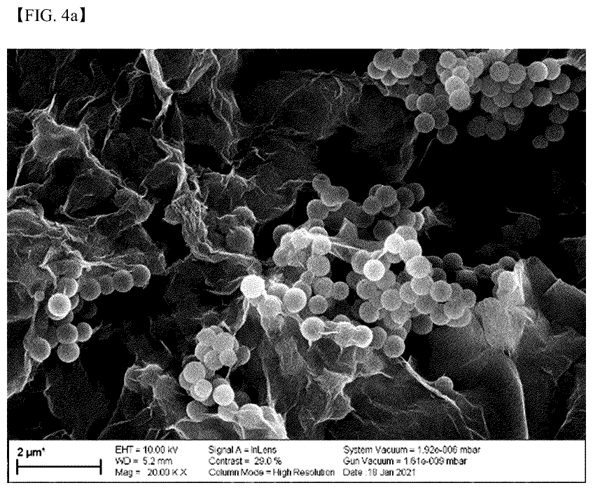

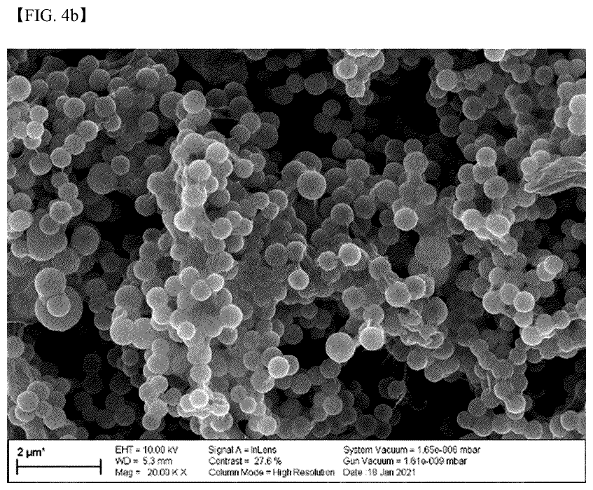

FIG. 4a illustrates an image of a silica particle-carbon allotrope composite, observed at a magnification of 20,000 using a scanning electron microscope, generated by reacting the pore-structured silica nanoparticles, which were not surface-modified with PVP and were synthesized with the TEOS precursor according to Comparative Example 1-2, with graphene oxide. Referring to the image, it can be seen that the surface bonding between graphene oxide and silica nanoparticles synthesized with the TEOS precursor is not even because the graphene oxide does not contain a surface modification additive that serves as anchoring.

FIG. 4b illustrates an image of a silica particle-carbon allotrope composite, observed at a magnification of 20,000 using a scanning electron microscope, generated by reacting the pore-structured silica nanoparticles surface-modified with PVP and synthesized with the TEOS precursor with graphene oxide according to Example 1-2. It can be seen that, when PVP is added as in Example 1-2, a homogeneous silica-carbon allotrope composite is formed, unlike FIG. 4a.

Here, PVP, a surface modification additive, is a polymer with an amide group, i.e., a polar functional group, and combines van der Waals with the ceramic nanoparticles and the carbon allotrope to ultimately create a carbon allotrope composite in which ceramic particles are homogeneously distributed.

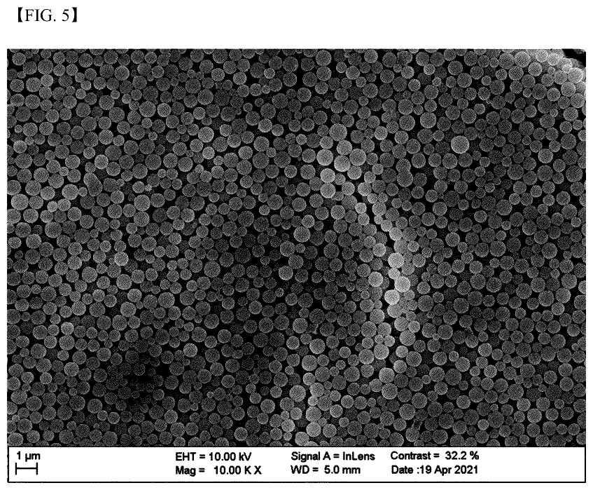

FIG. 5 illustrates an image of the pore-structured silica nanoparticles, observed at a magnification of 10,000 using a scanning electron microscope, containing PVP and synthesized with the TEV precursor according to Example 2-1. Referring to this, it can be seen that the silica nanoparticles are well dispersed due to the PVP surface modification additive so that there is no cohesion between the particles.

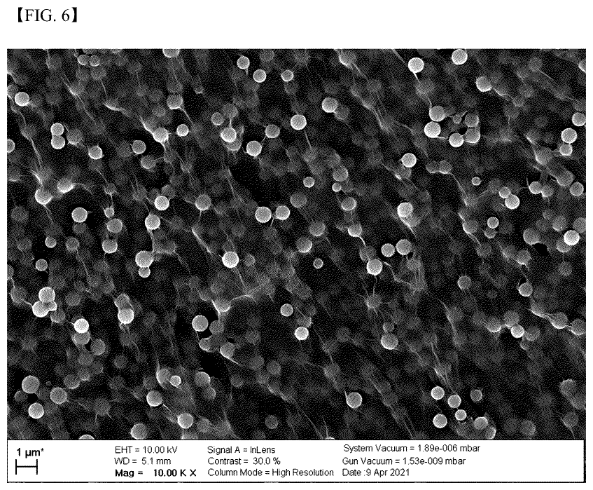

FIG. 6 illustrates an image of a pore-structured silica particle-carbon allotrope composite, observed at a magnification of 10,000 using a scanning electron microscope, generated by reacting the pore-structured silica nanoparticles surface-modified with PVP and synthesized with the TEV precursor according to Example 2-2 with graphene oxide. Referring to this drawing, it can seen that a silica-carbon allotrope composite with significantly excellent homogeneity is formed.

When manufacturing pore-structured ceramic nanoparticles, an ionic surfactant enables the synthesis of a ceramic shell on an emulsion surface and simultaneously serves to electrically neutralize the surface charge of ceramic particles. When using a TEV precursor containing organic molecules, it interferes with the surface adsorption behavior of an ionic surfactant, resulting in a relatively high surface charge. Therefore, in the case of the pore-structured ceramic nanoparticles synthesized from the TEV precursor, aggregation between the particles is suppressed, making it possible to synthesize a homogeneous composite.

### Characteristic Evaluation, Zeta Potential Measurement

The silica nanoparticles manufactured from each of the comparative examples and the examples were given a surface charge through emulsion polymerization. At this time, the aggregation or precipitation of silica nanoparticles is controlled due to the repulsive force between charges. the repulsive force is called “zeta potential”. Zeta potential was measured using ELSZ-2000ZS from Otsuka Electronics Co., Ltd.

The zeta potential of the silica nanoparticles synthesized with the TEOS precursor according to Comparative Example 1-1 was ±12.9 mV.

The zeta potential of the silica nanoparticles surface-modified with PVP and synthesized with the TEOS precursor according to Example 1-1 was ±20.1 mV.

The zeta potential of the silica nanoparticles surface-modified with PVP and synthesized with the TEV precursor according to Example 2-1 was ±41.9 mV.

The zeta potential of the silica nanoparticle-carbon allotrope composite which was not surface-modified with PVP and was synthesized with the TEOS precursor according to Comparative Example 1-2 was ±21.2 mV.

The zeta potential of the silica nanoparticle-carbon allotrope composite surface-modified with PVP and synthesized with TEOS precursor according to Example 1-2 was ±31.4 mV.

The zeta potential of the silica nanoparticle-carbon allotrope composite surface-modified with PVP and synthesized with the TEV precursor according to Example 2-2 was ±38.0 mV.

It can be seen that the absolute zeta potential values of the surface-modified Examples 1-1 and 2-1 increased compared to Comparative Example 1-1 without surface modification. Likewise, the absolute zeta potential values of Examples 1-2 and 2-2 also increased compared to Comparative Example 1-2. Accordingly, when the ceramic nanoparticles are surface-modified with a polymer containing a polar functional group, the absolute value of the surface charge of the particle increases, which strengthens their ability to repel each other, reduces cohesion between particles, and stabilizes the state. Therefore, the control of cohesion of ceramic nanoparticles can be confirmed by the increase in the absolute value of zeta potential. The surface-modified ceramic nanoparticles have a zeta potential range of ±20 mV to ±50 mV. The surface-modified the ceramic nanoparticle-carbon allotrope composite has a zeta potential range of ±30 mV to ±50 mV.

Ceramic nanoparticles have properties such as electrochemical activity, chemical durability, and optical refractive index. The pore-structured ceramic nanoparticle-carbon allotrope composite can be applied as an active electrode material for secondary batteries, a 5G low-dielectric material, and a radiant heat dissipation material.

Although the present invention has been described through limited examples and figures, the present invention is not intended to be limited to the examples. Those skilled in the art will appreciate that various modifications, additions and substitutions are possible, without departing from the scope and spirit of the invention. Therefore, it should be understood that there is no intent to limit the invention to the embodiments disclosed, rather, the invention is to cover all modifications, equivalents, and alternatives falling within the spirit and scope of the invention as defined by the claims.

1. A method of manufacturing pore-structured ceramic nanoparticles, the method comprising:
a step (S100) of adding a surfactant to a solvent to produce a first mixed solution;
a step (S200) of adding a ceramic precursor to the first mixed solution to produce a second mixed solution; and
a step (S300) of adding a surface modification additive to the second mixed solution to obtain ceramic nanoparticles having controlled cohesion.

2. The method according to claim 1, wherein the solvent comprises alcohol and water.

3. The method according to claim 2, wherein a volume ratio of the alcohol to water is 0.30 to 0.80.

4. The method according to claim 1, wherein the surfactant is one selected from the group consisting of cetrimonium bromide (CTAB), triethylamine hydrochloride (TAHC), benzethonium chloride (BTC), cetylpyridinium chloride (CPC) dimethyldioctadecylammonium chloride (DOAC), sodiumdodecylsulfate (SDS), sodiumdodecylbenzenesulfonate (SDBS) and dodecyltrimethylammonium bromide (DTAB).

5. The method according to claim 1, wherein the ceramic precursor is one selected from the group consisting of tetraethylorthosilicate (TEOS), triethoxyvinylsilane (TEV), (3-mercaptopropyl) trimethoxysilane (MPTMS), tetramethoxysilane (TMOS), triethoxyethylsilane (TEES), 1,2-bis(triethoxysilyl)ethane (BTSE), zirconium tert-butoxide, zirconium ethoxide, zirconium propoxide, titanium ethoxide, titanium isopropoxide, aluminum isopropoxide, aluminum-tri-sec-butoxide, aluminum tert-butoxide, hafnium n-butoxide, hafnium tert-butoxide, vanadium oxytriethoxide, vanadium oxytripropoxide, vanadium oxytriisopropoxide, yttrium tris(isopropoxide) and tin(IV) tert-butoxide.

6. The method according to claim 1, wherein ceramic of the ceramic precursor is one selected from the group consisting of silica (SiO₂), zirconium oxide (ZrO₂), titanium oxide (TiO₂), aluminum oxide (Al₂O₃), hafnium oxide (HfO₂), vanadium oxide (V₂O₃), yttrium oxide (Y₂O₃) and tin oxide (SnO and SnO₂).

7. The method according to claim 1, wherein the surface modification additive is a polymer comprising a polar functional group,
wherein the polar functional group is one selected from the group consisting of a sulfonyl group, an amino group, an amide group, an ether group, a carboxyl group and a hydroxyl group.

8. The method according to claim 7, wherein the polymer is one selected from the group consisting of poly(sodium 4-styrene-sulfonate (PSS), poly(allyl-amine hydrochloride) (PAH), poly(diallyldimethylammonium chloride) (PDAC), polyvinyl pyrrolidone (PVP), poly(N,N-dimethylacrylamide), poly(2-methyl-2-oxazoline), polyvinyl alcohol (PVA), polyethylenimine (PEI), polypropylene glycol (PPG), polyethylene glycol (PEG) and poly(acrylic acid) (PAA).

9. The method according to claim 1, wherein the ceramic nanoparticles have a zeta potential value of ±20 mV to ±50 mV.

10. A method of manufacturing a porous-structured ceramic nanoparticle-carbon allotrope composite, the method comprising:
a step (S100) of adding a surfactant to a solvent to produce a first mixed solution;
a step (S200) of adding a ceramic precursor to the first mixed solution to produce a second mixed solution;
a step (S400) of adding a surface modification additive to the second mixed solution to produce a third mixed solution; and
a step (S500) of adding the third mixed solution to a carbon allotrope dispersion solution to obtain a porous-structured ceramic nanoparticle-carbon allotrope composite having controlled cohesion.

11. The method according to claim 10, wherein the carbon allotrope is one selected from the group consisting of graphene, graphene oxide, graphene nanoribbon (GNR), carbon nanotube, carbon nanofiber, graphite, and expanded graphite.

12. Pore-structured ceramic nanoparticles having controlled cohesion, manufactured according to claim 1.

13. The pore-structured ceramic nanoparticles according to claim 12, wherein the ceramic nanoparticles have a zeta potential value of ±20 mV to ±50 mV.

14. A porous-structured ceramic nanoparticle-carbon allotrope composite having controlled cohesion, manufactured by the method according to claim 10.

15. The porous-structured ceramic nanoparticle-carbon allotrope composite according to claim 14, wherein the ceramic nanoparticle-carbon allotrope composite has a zeta potential value of ±30 mV to ±50 mV.
